(19) United States
(12) Patent Application Publication
(10) Pub. No.: US 2012/0190788 A1
(43) Pub. Date: Jul. 26, 2012

(54) COLORING PARTICLES

(75) Inventors: Takayuki Hiratani, Tokyo (JP); Kazumichi Nakahama, Tokyo (JP); Shoji Koike, Yokohama-shi (JP)

(73) Assignee: CANON KABUSHIKI KAISHA, Tokyo (JP)

(21) Appl. No.: 13/354,600

(22) Filed: Jan. 20, 2012

(30) Foreign Application Priority Data
Jan. 26, 2011 (JP) 2011-013914

(51) Int. Cl. C09D 133/02; B05D 7/00; C09D 11/00; B82Y 30/00

(52) U.S. Cl. 524/556; 427/213.3; 427/213.31; 977/773; 977/902

(57) ABSTRACT

Coloring particles contain a dye and a polymeric dispersant, and particles of the dye are coated on their surface with the polymeric dispersant. The average particle size of the coloring particles is in a range of 10 nm to 80 nm, inclusive, and the dye content is in a range of 60% by mass to 90% by mass, inclusive. The polymeric dispersant is insoluble in water of pH 6.0 to 8.0, inclusive, and the dye has a solubility parameter of equation (1) equal to or larger than 9.20 in water of pH 6.0 to 11.0, inclusive.

### BACKGROUND OF THE INVENTION

1. Field of the Invention

The present invention relates to coloring particles.

2. Description of the Related Art

When an ink containing coloring particles such as pigment is applied to a recording medium, the coloring particles are desirably fine in size, so that the light scattering caused by the coloring particles on the recording medium can be reduced. Reducing light scattering in this way allows the image density on the recording medium to be effectively increased as the coloring particle content in the ink solution is increased. Furthermore, fine coloring particles are easy to densely pack in the ink-absorbing layer of a recording medium or pores on a supporting medium, and can physically interact with the layer or pores to impart good rubfastness to the image.

Fine coloring particles can be prepared by some known means, including mechanical processes using a sand mill, a roll mill, a ball mill, or any other suitable disperser (see Japanese Patent Laid-Open Nos. 5-112732 and 8-302229).

However, fine coloring particles obtained by mechanical processes such as those in the above publications are likely to reaggregate because of overdispersion, and thus their minimum possible particle size is approximately 90 nm. Worse yet, making coloring particles finer by these processes requires long periods of time and large amounts of electric power and thus is impractical in terms of manufacturing cost. Furthermore, mechanical processes may damage the monodispersity of the coloring particles.

### SUMMARY OF THE INVENTION

Aspects of the present invention provide fine coloring particles with which high-density images can be recorded.

More specifically, aspects of the present invention provide coloring particles containing a dye and a polymeric dispersant. The particles of the dye are coated with the polymeric dispersant. The average particle size of the coloring particles is in a range of 10 nm to 80 nm, inclusive, and the dye content is in a range of 60% by mass to 90% by mass, inclusive. The polymeric dispersant is insoluble in water of pH 6.0 to 8.0, inclusive, and the dye has a solubility parameter of equation (1) equal to or larger than 9.20 in water of pH 6.0 to 11.0, inclusive:

Solubility parameter=log (1/Water solubility of the dye, mol/L). (1)

Constituted as above, aspects of the present invention can provide fine coloring particles with which high-density images can be recorded.

Further features of the present invention will become apparent from the following description of exemplary embodiments with reference to the attached drawings.

### BRIEF DESCRIPTION OF THE DRAWINGS

FIG. 1 illustrates an example of manufacturing methods of the coloring particles according to aspects of the present invention.

FIG. 2 illustrates another example of manufacturing methods of the coloring particles according to aspects of the present invention.

### DESCRIPTION OF THE EMBODIMENTS

The coloring particles according to aspects of the present invention contain a dye and a polymeric dispersant, and the particles of the dye are coated on their surface with the polymeric dispersant. The following details a constitution of the coloring particles according to aspects of the present invention.

The coloring particles according to aspects of the present invention have an average particle size in a range of 10 nm to 80 nm, inclusive, such as equal to or smaller than 50 nm. When the average particle size is in a range of 10 nm to 80 nm, inclusive, the image formed on a recording medium such as paper has a high image density because the light scattering caused by the coloring particles is reduced, and the coloring particles physically interact with micropores existing on the ink-receiving layer of the recording medium or on a supporting medium and thereby improve the rubfastness of the image. If it is smaller than 10 nm, however, the image formed on a recording medium tends to have insufficient resistance to light and/or gases. If it is larger than 80 nm, the image formed on a recording medium tends to have relatively low image density and rubfastness. According to aspects of the present invention, the average particle size of coloring particles is a value measured in water by dynamic light scattering. An example of particle size analyzers based on dynamic light scattering is DLS-8000 (Otsuka Electronics Co., Ltd.).

The coefficient of variation of particle size of the coloring particles according to aspects of the present invention may be equal to or lower than 60%, such as equal to or lower than 50%, and even equal to or lower than 40%. If it is higher than 60%, ink compositions containing the coloring particles may have relatively low dispersion stability, and the storage stability and ejection stability of the ink compositions may be accordingly low, and worse yet the image formed on a recording medium may have relatively low rubfastness because the coloring particles are unlikely to interact with fine pores on the ink-receiving layer of the recording medium or on a supporting medium. The coefficient of variation of particle size of coloring particles is calculated from the standard deviation of particle sizes and the average particle size of the coloring particles by the equation below. The coefficient of variation can be calculated whether the average particle size is measured by a dry or wet method.

Coefficient of variation, %=(Standard deviation of particle sizes of the coloring particles/Average particle size of the coloring particles)×100

The coloring particles according to aspects of the present invention may have high sphericity, or more specifically an average aspect ratio in a range of 1.0 to 1.2, inclusive. The average aspect ratio of coloring particles used in aspects of the present invention can be obtained by calculating the ratio of the major axis to the minor axis of the coloring particles 1000 times using a scanning electron microscope (SEM) or a transmission electron microscope (TEM) and then determining the number average of the values. Highly spherical coloring particles impart good fluidity to ink compositions containing them, and such ink compositions have favorable ejection properties.

The dye contained in the coloring particles according to aspects of the present invention (hereinafter simply referred to as the dye for aspects of the present invention) has a solubility parameter of equation (1) equal to or larger than 9.20 in water of pH 6.0 to 11.0, inclusive:

Solubility parameter=log (1/Water solubility of the dye, mol/L). (1)

For the solubility parameter of equation (1), the smaller the value is, the more water-soluble the dye is, and the larger the value is, the less water-soluble the dye is. Fine and highly monodispersed coloring particles intended according to aspects of the present invention may contain a dye hardly soluble in the water contained in the second liquid described later. The present inventors have found that stable formation of coloring particles is difficult when the solubility parameter is smaller than 9.20, and this is presumably because dyes having a solubility parameter smaller than 9.20 are soluble in water though slightly, and thus may affect the dispersion stability of the coloring particles. The solubility parameter of equation (1) is a value measured in water at a temperature of 25° C.

The solubility parameter of the dye, however, may vary depending on the pH of the water containing it. Thus, the dye may be dissolved in water having its pH adjusted by any known method so that the solubility parameter of the dye is equal to or higher than 9.20. Considering the fact that the broadest possible range of the pH of water during the preparation of ink is 6.0 to 11.0, the coloring particles can be formed in a stable manner if the solubility parameter of the dye is always equal to or higher than 9.20 when the pH of the water containing it varies in a range of 6.0 to 11.0.

The solubility parameter used according to aspects of the present invention can be calculated by measuring the degree of water solubility (mol/L) of the dye by any known experimental method and then substituting the measurement into equation (1). However, the solubility parameter used according to aspects of the present invention may be calculated by determining the degree of water solubility (mol/L) of the dye using ACD/Structure Design Suite (Fujitsu Ltd.) and then substituting the obtained value into equation (1). Needless to say, the water solubility in equation (1) is the solubility in water of pH 6.0 to 11.0, inclusive. The present inventors have confirmed that the values of the solubility parameter calculated in this way excellently agree with experimental results. For dyes such as metal complex dyes and salt dyes, the metal or salt is first removed, and then the degree of solubility is calculated using ACD/Structure Design Suite and the solubility parameter is calculated from the value.

The dye according to aspects of the present invention includes disperse dyes, metal complex dyes, acid dyes, direct dyes, and oil-soluble dyes obtained as salts of a water-soluble dye and a long-chain base such as salt dyes as combinations of a reactive dye and a long-chain amine as long as they satisfy the above requirements.

The polymeric dispersant according to aspects of the present invention is insoluble in water of pH 6.0 to 8.0, inclusive. Since the polymeric dispersant is insoluble in water of pH 6.0 to 8.0, inclusive, ink compositions containing the coloring particles according to aspects of the present invention, for example, are advantageous in the following ways: the dissolution of the dye in the ink composition is prevented, and thereby adequate dispersion stability of the coloring particles is ensured; increases in the viscosity of the ink composition are prevented, and thereby adequate ejection properties are ensured; and the portions ejected onto a recording medium are well absorbed, and thereby adequate fixing properties are ensured. Whether or not the polymeric dispersant is water-insoluble is judged in water at 25° C.

Depending on the value of pH, the polymer dispersant according to aspects of the present invention is soluble in water of pH<6.0 or >8.0. This polymer dispersant, which can be water-soluble or water-insoluble depending on the conditions, imparts favorable properties to the coloring particles. A specific example is amphiphilic polymeric dispersants, which are compounds having both hydrophobic and hydrophilic moieties. The polymeric dispersant may have in its hydrophilic moiety a carboxy group, an amino group, or any other functional group whose degree of dissociation is pH-dependent. Specific examples of the hydrophobic moiety of the polymeric dispersant include styrene and its derivatives such as α-methylstyrene, vinylcyclohexane, vinylnaphthalene derivatives, polymers such as acrylates and methacrylates, and copolymers of these polymers.

According to aspects of the present invention, whether the polymer dispersant is water-insoluble or -soluble is judged by the following solubility test. First, 2 parts by mass of the polymer dispersion under test is added to 100 parts by mass of water to make a liquid mixture. The obtained liquid mixture is shaken at 25° C. for 24 hours and then allowed to stand for another 24 hours. After that, the transmittance of the light having a wavelength of 550 nm through the liquid mixture is measured. When the transmittance is equal to or higher than 99%, the polymeric dispersant is water-soluble. When the transmittance is smaller than 99%, the polymeric dispersant is water-insoluble. An example of suitable apparatuses for the measurement of the transmittance is U-2001 Double Beam Spectrophotometer (Hitachi High-Technologies, Ltd.).

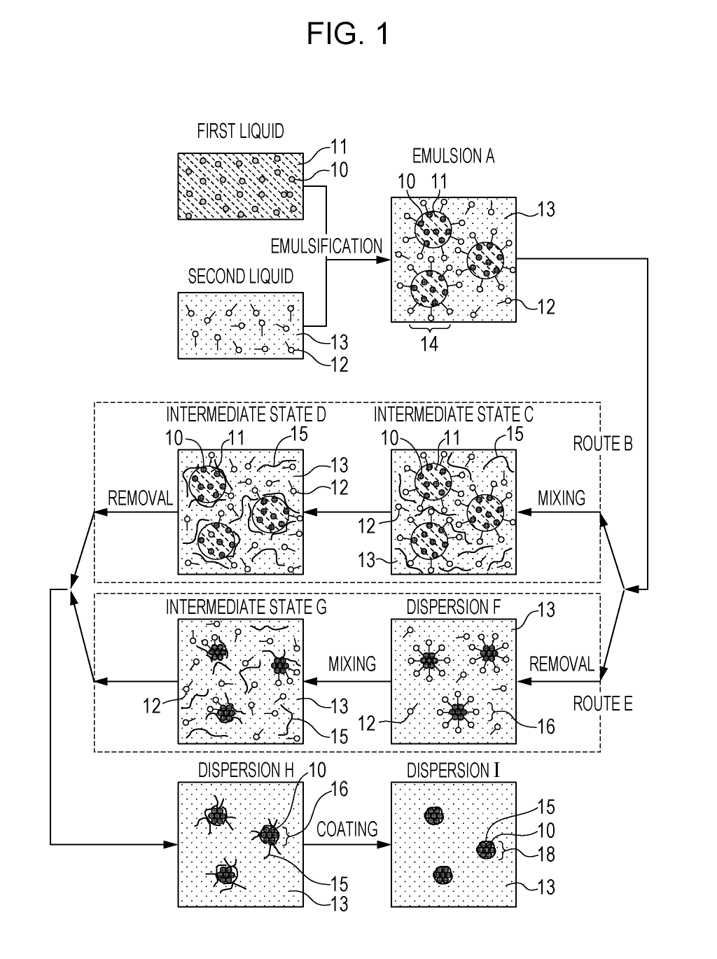

The weight-average molecular weight of the polymeric dispersant according to aspects of the present invention may be equal to or higher than 3000. When having a weight-average molecular weight equal to or higher than 3000, the polymeric dispersant can often efficiently adsorb the dispersoid and the particles of the dye. Also, the weight-average molecular weight of the polymeric dispersant may be equal to or lower than 1000000. If the polymeric dispersant has a weight-average molecular weight higher than 1000000, the mixture of the polymeric dispersant and emulsion A or dispersion F in FIG. 1 may have a significantly increased viscosity because of intra- and intermolecular entanglements of the polymeric dispersant. The weight-average molecular weight can be measured by various known methods such as light scattering, small-angle X-ray scattering, sedimentation equilibrium, diffusion, ultracentrifugation, and chromatographic analyses. The weight-average molecular weight of the polymeric dispersant may be in a range of 5000 to 1000000, inclusive, in particular, 5000 to 20000, inclusive. According to aspects of the present invention, the weight-average molecular weight of the polymeric dispersant is a polystyrene-equivalent value measured by gel permeation chromatography (GPC).

The coloring particles according to aspects of the present invention are particles of the dye coated on their surface with the polymeric dispersant. The dye content of the coloring particles is in a range of 60% by mass to 90% by mass, inclusive, relative to the total mass of the coloring particles. If the dye content is lower than 60% by mass, the image recorded on a recording medium with an ink composition containing the coloring particles may have an insufficient image density. This is because the portion of the polymeric dispersant scarcely contributing to color development is too large for the amount of the dye. If the dye content exceeds 90% by mass, however, stable dispersion of the coloring particles in an ink composition may be difficult.

The polymeric dispersant content of the coloring particles according to aspects of the present invention may be chosen so that the total content including the dye does not exceed 100% by mass, and it may be in a range of 10% by mass to 40% by mass, inclusive, relative to the total mass of the coloring particles. If it exceeds 40% by mass, the dye content of the coloring particles is accordingly low, and this causes the image recorded using the coloring particles to have a low image density. If it is lower than 10% by mass, however, ink compositions containing the coloring particles may be somewhat lacking in dispersion stability. In addition, the coloring particles according to aspects of the present invention may further contain auxiliary additives such as ultraviolet absorbers and antiseptics.

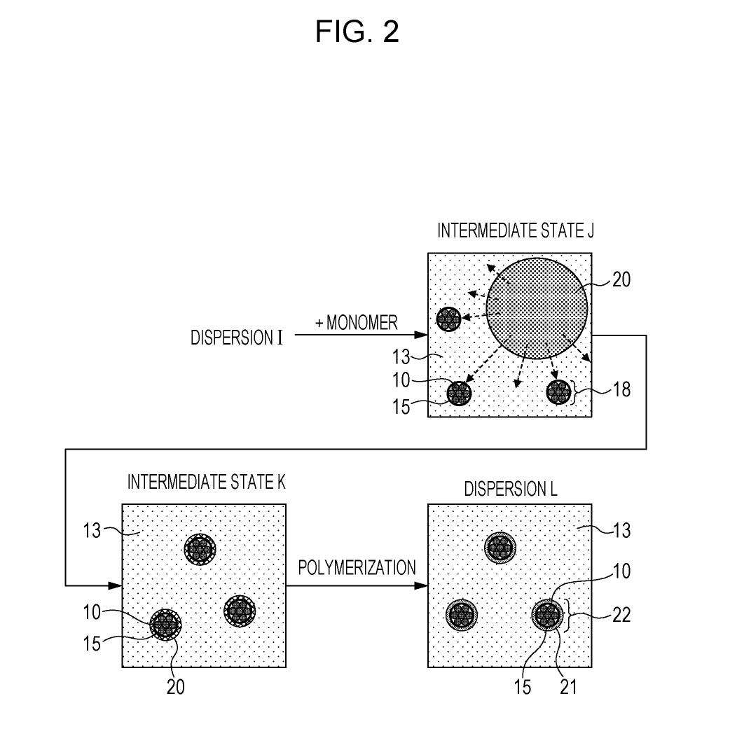

For the coloring particles according to aspects of the present invention, the particles of the dye may be coated on their surface with, in addition to the polymeric dispersant, a polymer having a structure different from that of the polymeric dispersant. This polymer may also be insoluble in water of pH 6.0 to 8.0. To be insoluble in water of pH 6.0 to 8.0, the polymer may have a hydrophobic moiety in its chemical structure. Examples of the hydrophobic moiety include styrene and its derivatives such as α-methylstyrene, vinylcyclohexane, vinylnaphthalene derivatives, polymers such as acrylates and methacrylates, and copolymers of these polymers. Additionally, the polymer may have a hydrophilic moiety such as a carboxy group, an amino group, a hydroxy group, and a sulfate group to impart dispersion stability to the coloring particles. This polymer can be obtained by the polymerization of a monomer in FIG. 2 described later. Examples of monomers for giving a hydrophobic moiety to the polymer include polymerizable unsaturated aromatic compounds and polymerizable carboxylates. Examples of suitable polymerizable unsaturated aromatic compounds include styrene, chlorostyrene, α-methylstyrene, divinylbenzene, and vinyltoluene. Examples of suitable polymerizable carboxylates include methyl(meth)acrylate, ethyl(meth)acrylate, n-butyl(meth)acrylate, 2-hydroxyethyl(meth)acrylate, glycidyl(meth)acrylate, ethylene glycol di(meth)acrylate, and tribromophenyl(meth)acrylate. Examples of monomers giving a hydrophilic moiety to the polymer include polymerizable carboxylic acids such as acrylic acid, itaconic acid, maleic acid, and fumaric acid. These monomers may be used alone or in combination of two or more kinds.

The combined content of the polymeric dispersant and the polymer of the coloring particles according to aspects of the present invention may be chosen so that the total content including the dye does not exceed 100% by mass, and it may be in a range of 10% by mass to 40% by mass, inclusive, relative to the total mass of the coloring particles. If it exceeds 40% by mass, the dye content of the coloring particles is accordingly low, and this causes the image recorded using the coloring particles to have a low image density. If it is lower than 10% by mass, ink compositions containing the coloring particles may be somewhat lacking in dispersion stability. According to aspects of the present invention, the amount of the monomer used in the monomer polymerization may be appropriately adjusted so that the combined content of the polymeric dispersant and the polymer falls within the above range.

The following describes a method for preparing the coloring particles according to aspects of the present invention with reference to FIG. 1.

The first liquid in FIG. 1 is a liquid containing lipid solvent 11 and dye 10. The dye 10 may be dissolved in the lipid solvent 11. The second liquid is a liquid containing water 13 and a low-molecular-weight dispersant 12. The low-molecular-weight dispersant 12 may be dissolved in the water 13.

The first operation is emulsification, in which the first liquid and the second liquid are mixed and emulsified to provide emulsion A containing the first liquid as a dispersoid 14. The dispersoid 14 contains the dye 10 and the lipid solvent 11, and particles thereof are dispersed in the water 13 by the action of the low-molecular-weight dispersant 12. Emulsion A is further processed to provide dispersion H by either of the following routes: route B via intermediate state C and intermediate state D, or route E via dispersion F and intermediate state G.

First, route B is described. In route B, the emulsification is followed by mixing, in which emulsion A obtained by the emulsification is mixed with a polymeric dispersant 15 (a polymeric dispersant insoluble in water of pH 6.0 to 8.0) to reach intermediate state C. In intermediate state C, the polymeric dispersant 15 is dissolved in the water 13. In general, polymeric dispersants, which adsorb particles at multiple points, can adsorb particles more strongly than low-molecular-weight ones, which adsorb particles at a single point. Therefore, in intermediate state D, which comes after intermediate state C, the particles of the dispersoid 14 are desorbed from the molecules of the low-molecular-weight dispersant 12, while the particles of the dispersoid 14 spontaneously adsorb the molecules of the polymeric dispersant 15 and get into a stable dispersion state. The mixing is followed by removal, in which the molecules of the lipid solvent 11 are removed from the particles of the dispersoid 14 to leave spherical aggregates of the dye 10, namely dye particles 16. These operations provide dispersion H, in which the dispersion state of the dye particles 16 (cores) is stabilized by the molecules of the polymeric dispersant 15 (shells).

Next, route E is described. In route E, the emulsification is followed by removal, in which the molecules of the lipid solvent 11 are removed from the particles of the dispersoid 14 to leave dye particles 16 as spherical aggregates of the dye 10, providing dispersion F. In dispersion F, the dispersion state of the dye particles 16 are stabilized by the molecules of the low-molecular-weight dispersant 12. The removal is followed by mixing, in which the emulsion is mixed with a polymeric dispersant 15 to reach intermediate state G. In intermediate state G, the polymeric dispersant 15 is dissolved in the water 13; however, the particles of the dispersoid 14 get desorbed from the molecules of the low-molecular-weight dispersant 12 over time, while the dye particles 16 spontaneously adsorb the molecules of the polymeric dispersant 15 and get into a stable dispersion state. These operations also provide dispersion H, in which the dispersion state of the dye particles 16 (cores) is stabilized by the molecules of the polymeric dispersant 15 (shells).

In this way, dispersion H (emulsion) is obtained by route B or route E. The next operation is coating, in which the pH of the emulsion is changed until the molecules of the polymeric dispersant 15 separate out on the surface of the dye particles 16 to a sufficient extent so that the dye particles 16 are be coated on their surface with the polymeric dispersant 15. In this way, dispersion I containing coloring particles 18 is obtained. In dispersion I, the dispersion state of the coloring particles 18 is stabilized by the electrostatic repulsion from and the excluded volume effect of the molecules of the polymeric dispersant 15.

Purification of the emulsion by the removal of the low-molecular-weight dispersant 12 may be performed after the mixing, removal, or coating. Impurities that may be produced during the removal, such as residue on evaporation, may also be removed in the purification.

According to aspects of the present invention, the formation of the coloring particles 18 may be followed by monomer adsorption, in which molecules of a monomer are adsorbed onto those of the polymeric dispersant 15 on the coloring particles 18, and polymerization, in which the monomer is polymerized. The following describes these operations with reference to FIG. 2.

Intermediate state J in FIG. 2 is a state in which a monomer 20 has been added to dispersion I (emulsion) containing the coloring particles 18. As time goes by, the molecules of the monomer 20 get adsorbed onto those of the polymeric dispersion 15 existing on the surface of the dye particles 16 of the coloring particles 18, and intermediate state K is reached. The monomer adsorption is followed by polymerization, in which the monomer 20 is polymerized. The polymerization of the monomer 20 provides dispersion L, which contains coloring particles 22 coated with a polymer 21 of the monomer 20 and the polymeric dispersant 15. The order of stacking of the two layers on the coloring particles 22, namely the layers of the polymeric dispersant 15 and the polymer 21, may be the same as in FIG. 2 or reversed from that in FIG. 2. A random structure, in which there is no clear layer interface, is also acceptable.

Next, the individual operations of this method for preparing the coloring particles according to aspects of the present invention are described in more detail.

In the emulsification performed according to aspects of the present invention, the first liquid and the second liquid are emulsified using a stirring, shear, or other similar known apparatus that produces mechanical energy, including high-shear homogenizing mixers, ultrasonic homogenizers, high-pressure homogenizers, and thin-film-rotating high-speed mixers. Ultrasonic homogenizers, high-pressure homogenizers, and thin-film-rotating high-speed mixers may be used. In addition, the emulsification according to aspects of the present invention may be performed by an emulsifying method based on a surface-chemical mechanism, including membrane emulsification using SPG (shirasu [volcanic ash] porous glass) membranes and emulsification in microstructured reactors such as microchannels or microfluidic junctions. These apparatuses and processes may be used alone or in combination of two or more kinds. Furthermore, the emulsification performed according to aspects of the present invention may be a single operation or include two or more operations.

The mass ratio of the first liquid to the second liquid used in the emulsification performed according to aspects of the present invention (the first liquid/the second liquid) is in a range of 1/20 to 2/3, inclusive. This ratio may be in a range of 1/15 to 1/2, inclusive, such as 1/10 to 1/4, inclusive.

The mixing according to aspects of the present invention may be performed by dissolving the polymeric dispersant in a solvent in advance and then adding the obtained solution to emulsion A or dispersion F. The solvent for the polymeric dispersant may have the same characteristics as the water contained in the second liquid or in emulsion A. The pH of the solvent may be adjusted by the addition of reagents of known acids such as hydrochloric acid and/or reagents of known bases such as sodium hydrochloride so that the polymeric dispersant can be more soluble in the solvent. The amount of the polymeric dispersant used in the mixing performed according to aspects of the present invention is in a range of 10% by mass to 70% by mass, inclusive, relative to the total mass of the dye contained in the emulsion. When it is equal to or more than 10% by mass, the molecules of the polymeric dispersant can be efficiently adsorbed onto the particles of the dispersoid and the dye particles. When it is equal to or less than 70% by mass, the polymeric dispersant hardly separates out alone during the pH adjustment, and thus the molecules of the polymeric dispersant can be efficiently adsorbed onto the particles of the dispersoid and the dye particles.

The removal performed according to aspects of the present invention may include removing the lipid solvent from the dispersoid by pressure reduction and/or dialysis for higher throughput. The pressure reduction can be performed using various kinds of known pressure-reducing apparatuses such as evaporators. The dialysis can be performed by static methods using semipermeable membranes as well as using a dialyzer such as an ultrafiltration system.

The coating performed according to aspects of the present invention includes converting the polymeric dispersant from a water-soluble state to a water-insoluble state by changing the pH of the emulsion. The pH of the emulsion can be changed by the addition of reagents of known acids such as hydrochloric acid and/or reagents of known bases such as sodium hydrochloride. In this way, the molecules of the polymeric dispersant are made to separate out on the surface of the dye particles to a sufficient extent so that the dye particles may be coated on their surface with the polymeric dispersant. The coating with the polymeric dispersant can be confirmed by measuring the ζ-potential of the particles before and after the pH change and comparing the values. The ζ-potential can be measured using known measuring instruments such as ZEECOM (Microtec Co., Ltd.) and ELS-8000 (Otsuka Electronics Co., Ltd.).

The purification performed according to aspects of the present invention may include dialysis by a static method using semipermeable membranes or with a dialyzer such as an ultrafiltration system. When the removal includes dialysis, the removal and the purification may be simultaneously performed.

The monomer adsorption and polymerization performed according to aspects of the present invention include adding a monomer to the emulsion, adsorbing the monomer onto the molecules of the polymeric dispersant, and polymerizing the adsorbed monomer. The initiator for polymerizing the monomer may be added in any operation in FIGS. 1 and 2. The addition of an initiator in intermediate state J or K in FIG. 2 allows the initiator to efficiently react with the monomer. Examples of suitable initiators include radical initiators, cationic initiators, anionic initiators, and other known types of initiators. Radical initiators are easier to handle than other kinds. When a radical initiator is used, it may be a water-soluble or oil-soluble one. Water-soluble radical initiators allow the dye particles to be uniformly coated with the water-insoluble polymer and also impart good dispersion stability to the coloring particles. Examples of suitable radical initiators include the following: azo (azobisnitrile) initiators such as 2,2′-azobisisobutyronitrile, 2,2′-azobis-(2-methylpropanenitrile), 2,2′-azobis-(2,4-dimethylpentanenitrile), 2,2′-azobis-(2-methylbutanenitrile), 1,1′-azobis-(cyclohexanecarbonitrile), 2,2′-azobis-(2,4-dimethyl-4-methoxyvaleronitrile), 2,2′-azobis-(2,4-dimethylvaleronitrile), 3,2′-azobis-(2-amidinopropane)hydrochloride; peroxide initiators such as benzoyl peroxide, cumene hydroperoxide, hydrogen peroxide, acetyl peroxide, lauroyl peroxide, persulfates (e.g., ammonium persulfate), and peracid esters (e.g., t-butyl peroctoate and α-cumyl peroxypivalate); and other initiators such as ascorbic acid/iron (II) sulfate/sodium peroxydisulfate, t-butyl hydroperoxide/sodium pyrosulfite, t-butyl hydroperoxide/sodium hydroxymethanesulfinate. After the addition of an initiator, processes such as heating, irradiation with light, and pH adjustment are optionally performed to polymerize the monomer according to aspects of the present invention.

The lipid solvent used according to aspects of the present invention is an organic solvent that is hardly soluble in the water used according to aspects of the present invention and can form an interface with the water upon being mixed with it. The degree of water solubility of the lipid solvent may be equal to or smaller than 3% by mass in 97% by mass of water at 25° C. When it is equal to smaller than 3% by mass, a good emulsion can be formed during the emulsification. Furthermore, the lipid solvent may be an organic solvent whose boiling point is lower than that of water; this allows the lipid solvent to be easily removed from the particles of the dispersoid in the emulsion during the removal. The lipid solvent may be a solvent obtained by dissolving 1% or less by mass of the dye according to aspects of the present invention in 99% by mass of a lipid solvent at 25° C. Examples of such organic solvents include the following: halogenated hydrocarbons (e.g., dichloromethane, chloroform, chloroethane, dichloroethane, trichloroethane, and carbon tetrachloride); ketones (e.g., acetone, methyl ethyl ketone, and methyl isobutyl ketone); ethers (e.g., tetrahydrofuran, ethyl ether, and isobutyl ether); esters (e.g., ethyl acetate and butyl acetate); and aromatic hydrocarbons (e.g., benzene, toluene, and xylene).

The low-molecular-weight dispersant used according to aspects of the present invention is a dispersant whose molecular weight is equal to or lower than 1000. The use of a dispersant having a molecular weight exceeding 1000 may lead to increased viscosity of the water and make it difficult to form the emulsion during the emulsification. Furthermore, the dispersant having a molecular weight exceeding 1000 may inhibit the spontaneous adsorption of the molecules of the polymeric dispersant 15 onto the particles of the dispersoid 14 or the dye particles 16 in FIG. 1 because polymeric dispersants, which adsorb particles at multiple points, generally can adsorb particles more strongly than low-molecular-weight ones, which adsorb particles at a single point. The low-molecular-weight dispersant according to aspects of the present invention may be a water-soluble one. When a water-soluble low-molecular-weight dispersant is used, it may be a known anionic, cationic, or nonionic one. Examples of suitable anionic dispersants include the following: sodium, potassium, and ammonium salts and other similar salts in the form of dodecyl sulfonate, dodecylbenzene sulfonate, decylbenzene sulfonate, undecylbenzene sulfonate, tridecylbenzene sulfonate, or nonylbenzene sulfonate. Examples of suitable cationic dispersants include the following: cetyltrimethylammonium bromide, hexadecylpyridinium chloride, and hexadecyltrimethylammonium chloride. Examples of suitable nonionic dispersants include oxyethylene alkyl ethers.

The second liquid according to aspects of the present invention contains the low-molecular-weight dispersant at a concentration equal to or higher than double the critical micelle concentration. More specifically, according to aspects of the present invention, the water for the second liquid is adjusted to 25° C., and then the low-molecular-weight dispersant is added to the water in an amount that makes the dispersant's concentration equal to or higher than double the critical micelle concentration. The ratio of the concentration of the low-molecular-weight dispersant in the second liquid to the critical micelle concentration may be in a range of 2 to 100, inclusive, and such as 5 to 20, inclusive.

The emulsion used according to aspects of the present invention contains a dispersoid composed of the dye and the lipid solvent. The average particle size of the dispersant may be in a range of 10 nm to 1000 nm, inclusive, when measured by dynamic light scattering. When the dispersoid has a substantially single-peaked distribution of particle size, the monodispersity of the intended product, namely the coloring particles, is highly improved.

According to aspects of the present invention, the emulsion may be stabilized by adding a hydrophobe (a hydrophobic compound) to the lipid solvent. The hydrophobe may be one that is soluble in the lipid solvent (at a concentration equal to or higher than 3% by mass in 97% by mass of the lipid solvent at 20° C.) and has a degree of water solubility equal to or lower than 0.01 g/L. Specific examples of suitable hydrophobes include hexadecane, squalane, cyclooctane, and other linear, branched, or cyclic alkanes having 8 to 30 carbon atoms (C₈ to C₃₀), stearyl methacrylate, dodecyl methacrylate, and other C₈ to C₃₀ alkyl acrylates, cetyl alcohol and other C₈ to C₃₀ alkyl alcohols, decyl mercaptan and other C₈ to C₃₀ alkyl thiols, polymers such as polyurethanes, polyesters, and polystyrene, long-chain aliphatic or aromatic carboxylic acids, long-chain aliphatic or aromatic carboxylates, long-chain aliphatic or aromatic amines, ketones, halogenated alkanes, silanes, siloxanes, and isocyanates. The hydrophobe may be an alkane having 12 or more carbon atoms, and it may be an alkane having 20 or less carbon atoms.

### EXAMPLES

The following describes examples of the coloring particles according to aspects of the present invention and methods for preparing them; however, the present invention is not limited to these examples.

### Synthesis of a Polymeric Dispersant

Styrene and methacrylic acid were dissolved in toluene, and the solution was bubbled with nitrogen for 30 minutes. Subsequently, azobisisobutylonitrile was added to the solution, and the mixture was stirred at 60° C. for 2 hours. The solution was then added in drops to a large amount of methanol, and the precipitate was collected by filtration. In this way, a polymeric dispersant having a styrene-derived hydrophobic moiety and a methacrylic acid-derived hydrophilic moiety (a carboxy group) was synthesized. The weight-average molecular weight of the synthesized polymeric dispersant was measured by GPC to be 5800. Separately, the water solubility of the dispersant was evaluated using U-2001 Double Beam Spectrophotometer (Hitachi, Ltd.) in water of pH 6.0 to 8.0, and the dispersant proved to be insoluble in water of pH 6.0 to 8.0. In addition, this polymeric dispersant was soluble in water of pH 10.0 or higher.

### Example 1

Five (5.0) grams of dye 1, illustrated below, was added to and mixed with 97.5 g of chloroform to provide a liquid mixture in which dye 1 was dissolved. The liquid mixture was then added to 400.0 g of water (containing 6.0 g of sodium dodecyl sulfate and adjusted to pH 6.0 with hydrochloric acid). Subsequently, the liquid mixture was emulsified using an ultrasonic homogenizer (200 W) at 4° C. for 20 minutes to form emulsion. The solubility parameter of dye 1 was not lower than 9.20 in water of pH 6.0 to 11.0. Analysis with DLS-8000 (Otsuka Electronics Co., Ltd.) showed that the emulsion was a monodispersed emulsion that contained a dispersoid having a single-peaked distribution of particle size and an average particle size of 650 nm.

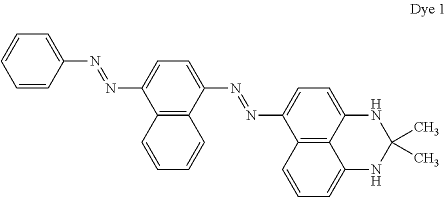

Subsequently, 2.0 g of the synthesized polymeric dispersant was dissolved in 50.0 g of sodium hydroxide aqueous solution (pH 11.0). The obtained solution was added to the above emulsion, and the mixture was stirred. The stirred mixture was vacuumed using an evaporator and thereby chloroform was removed from the dispersoid. After the completion of the removal, 1.0 N hydrochloric acid was slowly added to adjust the emulsion to pH 6.0. The emulsion was then purified by dialysis, and the purified emulsion was dispersed again in distilled water. In this way, the intended product, coloring particles 1, was obtained.

The ζ-potential of coloring particles 1 was evaluated using ZEECOM (Microtec Co., Ltd.), and the isoelectric point was found to be around pH 4.5. However, the dispersoid of the monodispersed emulsion had no isoelectric point. This confirmed that the coloring particles had a coating. Analysis with DLS-8000 (Otsuka Electronics Co., Ltd.) showed that coloring particles 1 had a single-peaked distribution of particle size and an average particle size of 52 nm and that the coefficient of variation of the average particle size was 56%. Observation under a transmission electron microscope showed that the average aspect ratio of the coloring particles was 1.2.

Coloring particles 1 were then lyophilized to dryness, the lyophilized powder was dissolved in chloroform, and the maximum absorption wavelength of the solution and the absorption intensity at that wavelength were measured by absorption spectrometry. Chloroform solutions containing dye 1 at predetermined concentrations were analyzed by absorption spectrometry to create a standard curve, and the absorption intensity measured above was compared with this standard curve; in this way, the ratio of the dye 1 content to the polymeric dispersant content of coloring particles 1 was determined. The dye 1 content of coloring particles 1 was 73% by mass relative to the total mass of the coloring particles; the polymeric dispersant content was 27% by mass.

### Example 2

Five (5.0) grams of dye 2, illustrated below, was added to and mixed with 97.5 g of chloroform to provide a liquid mixture in which dye 2 was dissolved. The liquid mixture was then added to 400.0 g of water (containing 6.0 g of sodium dodecyl sulfate and adjusted to pH 6.0 with hydrochloric acid). Subsequently, the liquid mixture was emulsified using an ultrasonic homogenizer (200 W) at 4° C. for 20 minutes to form emulsion. The solubility parameter of dye 2 was not lower than 9.20 in water of pH 6.0 to 11.0. Analysis with DLS-8000 (Otsuka Electronics Co., Ltd.) showed that the emulsion was a monodispersed emulsion that contained a dispersoid having a single-peaked distribution of particle size and an average particle size of 630 nm.

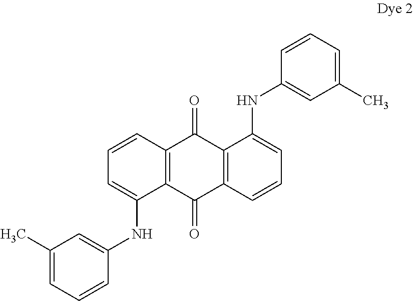

Subsequently, 3.0 g of the synthesized polymeric dispersant was dissolved in 50.0 g of sodium hydroxide aqueous solution (pH 11.0). The obtained solution was added to the above emulsion, and the mixture was stirred. The stirred mixture was vacuumed using an evaporator and thereby chloroform was removed from the dispersoid. After the completion of the removal, 1.0 N hydrochloric acid was slowly added to adjust the emulsion to pH 6.0. The emulsion was then purified by ultrafiltration, and the purified emulsion was dispersed again in distilled water. In this way, the intended product, coloring particles 2, was obtained.

The ζ-potential of coloring particles 2 was evaluated using ZEECOM (Microtec Co., Ltd.), and the isoelectric point was found to be around pH 4.5. However, the dispersoid of the monodispersed emulsion had no isoelectric point. This confirmed that the coloring particles had a coating. Analysis with DLS-8000 (Otsuka Electronics Co., Ltd.) showed that coloring particles 2 had a single-peaked distribution of particle size and an average particle size of 53 nm and that the coefficient of variation of the average particle size was 52%. Observation under a transmission electron microscope showed that the average aspect ratio of the coloring particles was 1.2.

Coloring particles 2 were then lyophilized to dryness, the lyophilized powder was dissolved in chloroform, and the maximum absorption wavelength of the solution and the absorption intensity at that wavelength were measured by absorption spectrometry. Chloroform solutions containing dye 2 at predetermined concentrations were analyzed by absorption spectrometry to create a standard curve, and the absorption intensity measured above was compared with this standard curve; in this way, the ratio of the dye 2 content to the polymeric dispersant content of coloring particles 2 was determined. The dye 2 content of coloring particles 2 was 65% by mass relative to the total mass of the coloring particles; the polymeric dispersant content was 35% by mass.

### Example 3

Six (6.0) grams of dye 3 (Solvent Blue 97), illustrated below, was added to and mixed with 97.5 g of chloroform to provide a liquid mixture in which dye 3 was dissolved. The liquid mixture was then added to 400.0 g of water (containing 6.0 g of sodium dodecyl sulfate and adjusted to pH 6.0 with hydrochloric acid). Subsequently, the liquid mixture was emulsified using an ultrasonic homogenizer (200 W) at 4° C. for 20 minutes to form emulsion. The solubility parameter of dye 3 was not lower than 9.20 in water of pH 6.0 to 11.0. Analysis with DLS-8000 (Otsuka Electronics Co., Ltd.) showed that the emulsion was a monodispersed emulsion that contained a dispersoid having a single-peaked distribution of particle size and an average particle size of 790 nm.

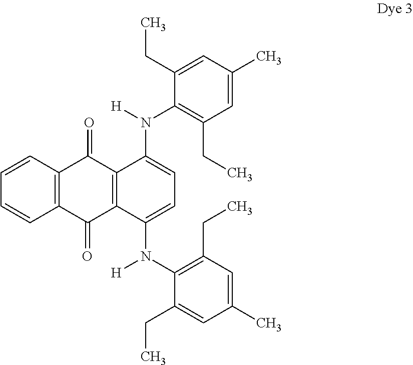

Subsequently, 2.0 g of the synthesized polymeric dispersant was dissolved in 50.0 g of sodium hydroxide aqueous solution (pH 11.0). The obtained solution was added to the above emulsion, and the mixture was stirred. The stirred mixture was vacuumed using an evaporator and thereby chloroform was removed from the dispersoid. After the completion of the removal, 1.0 N hydrochloric acid was slowly added to adjust the emulsion to pH 6.0. The emulsion was then purified by dialysis, and the purified emulsion was dispersed again in distilled water. In this way, the intended product, coloring particles 3, was obtained.

The ζ-potential of coloring particles 3 was evaluated using ZEECOM (Microtec Co., Ltd.), and the isoelectric point was found to be around pH 4.5. However, the dispersoid of the monodispersed emulsion had no isoelectric point. This confirmed that the coloring particles had a coating. Analysis with DLS-8000 (Otsuka Electronics Co., Ltd.) showed that coloring particles 3 had a single-peaked distribution of particle size and an average particle size of 78 nm and that the coefficient of variation of the average particle size was 56%. Observation under a transmission electron microscope showed that the average aspect ratio of the coloring particles was 1.2.

Coloring particles 3 were then lyophilized to dryness, the lyophilized powder was dissolved in chloroform, and the maximum absorption wavelength of the solution and the absorption intensity at that wavelength were measured by absorption spectrometry. Chloroform solutions containing dye 3 at predetermined concentrations were analyzed by absorption spectrometry to create a standard curve, and the absorption intensity measured above was compared with this standard curve; in this way, the ratio of the dye 3 content to the polymeric dispersant content of coloring particles 3 was determined. The dye 3 content of coloring particles 3 was 77% by mass relative to the total mass of the coloring particles; the polymeric dispersant content was 23% by mass.

### Example 4

Half a gram (0.5 g) of dye 3 (Solvent Blue 97) was added to and mixed with 0.95 g of chloroform to provide a liquid mixture in which dye 3 was dissolved. The liquid mixture was then added to 4.0 g of water (containing 0.8 g of sodium dodecyl sulfate and adjusted to pH 6.0 with hydrochloric acid). Subsequently, the liquid mixture was emulsified using an ultrasonic homogenizer (200 W) at 4° C. for 10 minutes to form emulsion. The solubility parameter of dye 3 was not lower than 9.20 in water of pH 6.0 to 11.0. Analysis with DLS-8000 (Otsuka Electronics Co., Ltd.) showed that the emulsion was a monodispersed emulsion that contained a dispersoid having a single-peaked distribution of particle size and an average particle size of 142 nm.

Subsequently, 0.33 g of the synthesized polymeric dispersant was dissolved in 2.0 g of sodium hydroxide aqueous solution (pH 11.0). The obtained solution was added to the above emulsion, and the mixture was stirred. The stirred mixture was vacuumed using an evaporator and thereby chloroform was removed from the dispersoid. After the completion of the removal, 1.0 N hydrochloric acid was slowly added to adjust the emulsion to pH 6.0. The emulsion was then purified by ultrafiltration, and the purified emulsion was dispersed again in distilled water. In this way, the intended product, coloring particles 4, was obtained.

The ζ-potential of coloring particles 4 was evaluated using ELS-8000 (Otsuka Electronics Co., Ltd.), and the isoelectric point was found to be around pH 4.8. However, the dispersoid of the monodispersed emulsion had no isoelectric point. This confirmed that the coloring particles had a coating. Analysis with DLS-8000 (Otsuka Electronics Co., Ltd.) showed that coloring particles 4 had a single-peaked distribution of particle size and an average particle size of 17 nm and that the coefficient of variation of the average particle size was 57%. Observation under a transmission electron microscope showed that the average aspect ratio of the coloring particles was 1.2.

Coloring particles 4 were then lyophilized to dryness, the lyophilized powder was dissolved in chloroform, and the maximum absorption wavelength of the solution and the absorption intensity at that wavelength were measured by absorption spectrometry. Chloroform solutions containing dye 3 at predetermined concentrations were analyzed by absorption spectrometry to create a standard curve, and the absorption intensity measured above was compared with this standard curve; in this way, the ratio of the dye 3 content to the polymeric dispersant content of coloring particles 4 was determined. The dye 3 content of coloring particles 4 was 61% by mass relative to the total mass of the coloring particles; the polymeric dispersant content was 39% by mass.

### Example 5

Six (6.0) grams of dye 3 (Solvent Blue 97) was added to and mixed with 97.5 g of chloroform to provide a liquid mixture in which dye 3 was dissolved. The liquid mixture was then added to 400.0 g of water (containing 7.0 g of sodium dodecyl sulfate and adjusted to pH 6.0 with hydrochloric acid). Subsequently, the liquid mixture was emulsified using an ultrasonic homogenizer (200 W) at 4° C. for 20 minutes to form emulsion. The solubility parameter of dye 3 was not lower than 9.20 in water of pH 6.0 to 11.0. Analysis with DLS-8000 (Otsuka Electronics Co., Ltd.) showed that the emulsion was a monodispersed emulsion that contained a dispersoid having a single-peaked distribution of particle size and an average particle size of 740 nm.

Subsequently, 2.0 g of the synthesized polymeric dispersant was dissolved in 50.0 g of sodium hydroxide aqueous solution (pH 11.0). The obtained solution was added to the above emulsion, and the mixture was stirred. The stirred mixture was vacuumed using an evaporator and thereby chloroform was removed from the dispersoid. After the completion of the removal, 1.0 N hydrochloric acid was slowly added to adjust the emulsion to pH 6.0. The emulsion was then purified by ultrafiltration, and the purified emulsion was dispersed again in distilled water. In this way, the intended product, coloring particles 5, was obtained.

The ζ-potential of coloring particles 5 was evaluated using ZEECOM (Microtec Co., Ltd.), and the isoelectric point was found to be around pH 4.5. However, the dispersoid of the monodispersed emulsion had no isoelectric point. This confirmed that the coloring particles had a coating. Analysis with DLS-8000 (Otsuka Electronics Co., Ltd.) showed that coloring particles 5 had a single-peaked distribution of particle size and an average particle size of 48 nm and that the coefficient of variation of the average particle size was 55%. Observation under a transmission electron microscope showed that the average aspect ratio of the coloring particles was 1.2.

Coloring particles 5 were then lyophilized to dryness, the lyophilized powder was dissolved in chloroform, and the maximum absorption wavelength of the solution and the absorption intensity at that wavelength were measured by absorption spectrometry. Chloroform solutions containing dye 3 at predetermined concentrations were analyzed by absorption spectrometry to create a standard curve, and the absorption intensity measured above was compared with this standard curve; in this way, the ratio of the dye 3 content to the polymeric dispersant content of coloring particles 5 was determined. The dye 3 content of coloring particles 5 was 74% by mass relative to the total mass of the coloring particles; the polymeric dispersant content was 26% by mass.

### Example 6

Six (6.0) grams of dye 3 (Solvent Blue 97) was added to and mixed with 97.5 g of chloroform to provide a liquid mixture in which dye 3 was dissolved. The liquid mixture was then added to 400.0 g of water (containing 7.0 g of sodium dodecyl sulfate and adjusted to pH 6.0 with hydrochloric acid). Subsequently, the liquid mixture was emulsified using an ultrasonic homogenizer (200 W) at 4° C. for 20 minutes to form emulsion. The solubility parameter of dye 3 was not lower than 9.20 in water of pH 6.0 to 11.0. Analysis with DLS-8000 (Otsuka Electronics Co., Ltd.) showed that the emulsion was a monodispersed emulsion that contained a dispersoid having a single-peaked distribution of particle size and an average particle size of 740 nm.

Subsequently, 1.5 g of the synthesized polymeric dispersant was dissolved in 50.0 g of sodium hydroxide aqueous solution (pH 11.0). The obtained solution was added to the above emulsion, and the mixture was stirred. The stirred mixture was vacuumed using an evaporator and thereby chloroform was removed from the dispersoid. After the completion of the removal, 1.0 N hydrochloric acid was slowly added to adjust the emulsion to pH 6.0. The emulsion was then purified by ultrafiltration, and the purified emulsion was dispersed again in distilled water.

An emulsion was prepared by emulsifying 1.5 g of styrene (monomer) in 10.0 g of distilled water, and this emulsion was added to the above dispersion. Subsequently, potassium persulfate, a radical initiator, was added, and the mixture was allowed to stand for 24 hours so that the monomer can be fully polymerized. The polymerization provided the target product, coloring particles 6, or more specifically dye particles coated with, in addition to the polymeric dispersant, a polymer formed by the polymerization.

The ζ-potential of coloring particles 6 was evaluated using ZEECOM (Microtec Co., Ltd.), and the isoelectric point was found to be around pH 4.5. However, the dispersoid of the monodispersed emulsion had no isoelectric point. This confirmed that the coloring particles had a coating. Analysis with DLS-8000 (Otsuka Electronics Co., Ltd.) showed that coloring particles 6 had a single-peaked distribution of particle size and an average particle size of 50 nm and that the coefficient of variation of the average particle size was 51%. Observation under a transmission electron microscope showed that the average aspect ratio of the coloring particles was 1.1.

Coloring particles 6 were then lyophilized to dryness, the lyophilized powder was dissolved in chloroform, and the maximum absorption wavelength of the solution and the absorption intensity at that wavelength were measured by absorption spectrometry. Chloroform solutions containing dye 3 at predetermined concentrations were analyzed by absorption spectrometry to create a standard curve, and the absorption intensity measured above was compared with this standard curve; in this way, the ratio of the dye 3 content to the polymeric dispersant content of coloring particles 6 was determined. The dye 3 content of coloring particles 6 was 66% by mass relative to the total mass of the coloring particles; the polymeric dispersant content was 34% by mass.

### Example 7

Six (6.0) grams of dye 3 (Solvent Blue 97) was added to and mixed with 97.5 g of chloroform to provide a liquid mixture in which dye 3 was dissolved. The liquid mixture was then added to 400.0 g of water (containing 6.0 g of sodium dodecyl sulfate and adjusted to pH 6.0 with hydrochloric acid). Subsequently, the liquid mixture was emulsified using an ultrasonic homogenizer (200 W) at 4° C. for 20 minutes to form emulsion. The solubility parameter of dye 3 was not lower than 9.20 in water of pH 6.0 to 11.0. Analysis with DLS-8000 (Otsuka Electronics Co., Ltd.) showed that the emulsion was a monodispersed emulsion that contained a dispersoid having a single-peaked distribution of particle size and an average particle size of 780 nm.

This emulsion was vacuumed using an evaporator and thereby chloroform was removed from the dispersoid.

Subsequently, 2.0 g of the synthesized polymeric dispersant was dissolved in 50.0 g of sodium hydroxide aqueous solution (pH 11.0). The obtained solution was added to the above emulsion, and the mixture was stirred. To the stirred mixture, 1.0 N hydrochloric acid was slowly added to adjust the emulsion to pH 6.0. The emulsion was then purified by ultrafiltration, and the purified emulsion was dispersed again in distilled water. In this way, the intended product, coloring particles 7, was obtained.

The ζ-potential of coloring particles 7 was evaluated using ZEECOM (Microtec Co., Ltd.), and the isoelectric point was found to be around pH 5.0. However, the dispersoid of the monodispersed emulsion had no isoelectric point. This confirmed that the coloring particles had a coating. Analysis with DLS-8000 (Otsuka Electronics Co., Ltd.) showed that coloring particles 7 had a single-peaked distribution of particle size and an average particle size of 75 nm and that the coefficient of variation of the average particle size was 55%. Observation under a transmission electron microscope showed that the average aspect ratio of the coloring particles was 1.2.

Coloring particles 7 were then lyophilized to dryness, the lyophilized powder was dissolved in chloroform, and the maximum absorption wavelength of the solution and the absorption intensity at that wavelength were measured by absorption spectrometry. Chloroform solutions containing dye 3 at predetermined concentrations were analyzed by absorption spectrometry to create a standard curve, and the absorption intensity measured above was compared with this standard curve; in this way, the ratio of the dye 3 content to the polymeric dispersant content of coloring particles 7 was determined. The dye 3 content of coloring particles 7 was 70% by mass relative to the total mass of the coloring particles; the polymeric dispersant content was 30% by mass.

### Comparative Example 1

Five (5.0) grams of dye 4, illustrated below, was added to and mixed with 97.5 g of chloroform to provide a liquid mixture in which dye 4 was dissolved. The liquid mixture was then added to 400.0 g of water (containing 6.0 g of sodium dodecyl sulfate and adjusted to pH 6.0 with hydrochloric acid). Subsequently, the liquid mixture was emulsified using an ultrasonic homogenizer (200 W) at 4° C. for 20 minutes to form emulsion. The solubility parameter of dye 4 in water of pH 6.0 was 9.10. Analysis with DLS-8000 (Otsuka Electronics Co., Ltd.) showed that the emulsion was a monodispersed emulsion that contained a dispersoid having a single-peaked distribution of particle size and an average particle size of 720 nm.

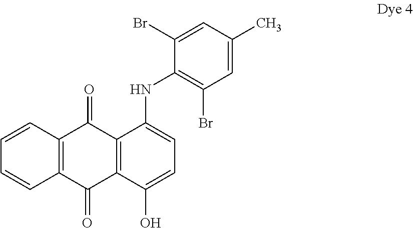

Subsequently, 2.0 g of the synthesized polymeric dispersant was dissolved in 50.0 g of sodium hydroxide aqueous solution (pH 11.0). The obtained solution was added to the above emulsion, and the mixture was stirred. The solubility parameter of dye 4 in water of pH 11.0 was 6.09. The stirred mixture was vacuumed using an evaporator and thereby chloroform was removed from the dispersoid, and the residue was stored for 24 hours under stirring, but aggregates had precipitated out during the storage; it was impossible to obtain a dispersion containing coloring particles.

### Comparative Example 2

Five (5.0) grams of dye 5 (Solvent Blue 35) was added to and mixed with 97.5 g of chloroform to provide a liquid mixture in which dye 5 was dissolved. The liquid mixture was then added to 400.0 g of water (containing 6.0 g of sodium dodecyl sulfate and adjusted to pH 11.0 with potassium hydroxide). Subsequently, the liquid mixture was emulsified using an ultrasonic homogenizer (200 W) at 4° C. for 20 minutes to form emulsion. The solubility parameter of dye 5 in water of pH 11.0 was 8.16. Analysis with DLS-8000 (Otsuka Electronics Co., Ltd.) showed that the emulsion was a monodispersed emulsion that contained a dispersoid having a single-peaked distribution of particle size and an average particle size of 690 nm.

Subsequently, 2.0 g of the synthesized polymeric dispersant was dissolved in 50.0 g of sodium hydroxide aqueous solution (pH 11.0). The obtained solution was added to the above emulsion, and the mixture was stirred. The stirred mixture was vacuumed using an evaporator and thereby chloroform was removed from the dispersoid, and the residue was stored for 24 hours under stirring, but aggregates had precipitated out during the storage; it was impossible to obtain a dispersion containing coloring particles.

### Comparative Example 3

Five point eight (5.8) grams of dye 3 (Solvent Blue 97) was added to and mixed with 97.5 g of chloroform to provide a liquid mixture in which dye 3 was dissolved. The liquid mixture was then added to 400.0 g of water (containing 6.0 g of sodium dodecyl sulfate and adjusted to pH 6.0 with hydrochloric acid). Subsequently, the liquid mixture was emulsified using an ultrasonic homogenizer (200 W) at 4° C. for 20 minutes to form emulsion. The solubility parameter of dye 3 was not lower than 9.20 in water of pH 6.0 to 11.0. Analysis with DLS-8000 (Otsuka Electronics Co., Ltd.) showed that the emulsion was a monodispersed emulsion that contained a dispersoid having a single-peaked distribution of particle size and an average particle size of 770 nm.

Subsequently, 6.0 g of the synthesized polymeric dispersant was dissolved in 100.0 g of sodium hydroxide aqueous solution (pH 11.0). The obtained solution was added to the above emulsion, and the mixture was stirred. The stirred mixture was vacuumed using an evaporator and thereby chloroform was removed from the dispersoid. After the completion of the removal, 1.0 N hydrochloric acid was slowly added to adjust the emulsion to pH 6.0. The emulsion was then purified by ultrafiltration, and the purified emulsion was dispersed again in distilled water. In this way, the intended product, coloring particles 8, was obtained.

The ζ-potential of coloring particles 8 was evaluated using ZEECOM (Microtec Co., Ltd.), and the isoelectric point was found to be around pH 4.5. However, the dispersoid of the monodispersed emulsion had no isoelectric point. This confirmed that the coloring particles had a coating. Analysis with DLS-8000 (Otsuka Electronics Co., Ltd.) showed that coloring particles 8 had a single-peaked distribution of particle size and an average particle size of 76 nm and that the coefficient of variation of the average particle size was 53%. Observation under a transmission electron microscope showed that the average aspect ratio of the coloring particles was 1.2.

Coloring particles 8 were then lyophilized to dryness, the lyophilized powder was dissolved in chloroform, and the maximum absorption wavelength of the solution and the absorption intensity at that wavelength were measured by absorption spectrometry. Chloroform solutions containing dye 3 at predetermined concentrations were analyzed by absorption spectrometry to create a standard curve, and the absorption intensity measured above was compared with this standard curve; in this way, the ratio of the dye 3 content to the polymeric dispersant content of coloring particles 8 was determined. The dye 3 content of coloring particles 8 was 50% by mass relative to the total mass of the coloring particles; the polymeric dispersant content was 50% by mass.

### Comparative Example 4

Five (5.0) grams of dye 3 (Solvent Blue 97) was added to and mixed with 97.5 g of chloroform to provide a liquid mixture in which dye 3 was dissolved. The liquid mixture was then added to 400.0 g of water (containing 1.0 g of sodium dodecyl sulfate and adjusted to pH 6.0 with hydrochloric acid). The critical micelle concentration of sodium dodecyl sulfate in water is 0.0025 g/mL; therefore, the second liquid used in Comparative Example 4 contained a low-molecular-weight dispersant at the critical micelle concentration and thus did not satisfy the requirement that the concentration of the low-molecular-weight dispersant should be equal to or higher than double the critical micelle concentration. Subsequently, the liquid mixture was emulsified using an ultrasonic homogenizer (200 W) at 4° C. for 20 minutes to form emulsion. The solubility parameter of dye 3 was not lower than 9.20 in water of pH 6.0 to 11.0. Analysis with DLS-8000 (Otsuka Electronics Co., Ltd.) showed that the emulsion had a multiple-peaked distribution of particle size; the distribution stability was so poor that the average particle size of the emulsion could not be determined.

Subsequently, 1.5 g of the synthesized polymeric dispersant was dissolved in 50.0 g of sodium hydroxide aqueous solution (pH 11.0). The obtained solution was added to the above emulsion, and the mixture was stirred. The stirred mixture was vacuumed using an evaporator and thereby chloroform was removed from the dispersoid. After the completion of the removal, 1.0 N hydrochloric acid was slowly added to adjust the emulsion to pH 6.0. The emulsion was then purified by ultrafiltration, and the purified emulsion was dispersed again in distilled water. The obtained dispersion contained aggregates and thus was isolated by filtering out the aggregates. In this way, coloring particles 9 were obtained.

Analysis with DLS-8000 (Otsuka Electronics Co., Ltd.) showed that coloring particles 9 had a single-peaked distribution of particle size although the peak was broad. The average particle size was 97 nm, and the coefficient of variation of the average particle size was 64%. Observation under a transmission electron microscope showed that the average aspect ratio of the coloring particles was 1.2.

Coloring particles 9 were then lyophilized to dryness, the lyophilized powder was dissolved in chloroform, and the maximum absorption wavelength of the solution and the absorption intensity at that wavelength were measured by absorption spectrometry. Chloroform solutions containing dye 3 at predetermined concentrations were analyzed by absorption spectrometry to create a standard curve, and the absorption intensity measured above was compared with this standard curve; in this way, the ratio of the dye 3 content to the polymeric dispersant content of coloring particles 9 was determined. The dye 3 content of coloring particles 9 was 71% by mass relative to the total mass of the coloring particles; the polymeric dispersant content was 29% by mass.

The measurements obtained in these examples and comparative examples are summarized in Table 1.

TABLE 1

| | | Average | Dye |
|---|---|---|---|
| | Solubility | particle | content |
| | parameter of | size of coloring | (% by |
| | dye | particles (nm) | mass) |
| Example 1 (coloring particles 1) | ≧9.20 | 52 | 73 |
| Example 2 (coloring particles 2) | ≧9.20 | 53 | 65 |
| Example 3 (coloring particles 3) | ≧9.20 | 78 | 77 |
| Example 4 (coloring particles 4) | ≧9.20 | 17 | 61 |
| Example 5 (coloring particles 5) | ≧9.20 | 48 | 74 |
| Example 6 (coloring particles 6) | ≧9.20 | 50 | 66 |
| Example 7 (coloring particles 7) | ≧9.20 | 75 | 70 |
| Comparative Example 1 | <9.20 | — | — |
| Comparative Example 2 | <9.20 | — | — |
| Comparative Example 3 | ≧9.20 | 76 | 50 |
| (coloring particles 8) | | | |
| Comparative Example 4 | ≧9.20 | 97 | 71 |
| (coloring particles 9) | | | |

### Image Density Test

Coloring particles 3 were added to a water-glycerol mixture in such a manner that the dye content and the glycerol content should be 5.0% by mass and 20.0% by mass, respectively. In this way, ink composition 1 was obtained. Separately, coloring particles 8 were added to a water-glycerol mixture in such a manner that the dye content and the glycerol content should be 5.0% by mass and 20.0% by mass, respectively. In this way, ink composition 2 was obtained.

With ink compositions 1 and 2, an image was printed on a recording medium (PR-101, CANON KABUSHIKI KAISHA) using a piezoelectric inkjet printer (PX-V630, Seiko Epson Corporation), and the printed images were visually evaluated. The image printed with ink composition 1 was much clearer than that printed with ink composition 2, indicating a much higher image density of the former.

### Rubfastness Test

Coloring particles 3, coloring particles 5, and coloring particles 9 were individually added to a water-glycerol mixture in such a manner that the dye content and the glycerol content should be 5.0% by mass and 20.0% by mass, respectively. In this way, ink compositions 3, 4, and 5 were obtained.

With ink compositions 3, 4, and 5, an image was printed on a recording medium (PR-101, CANON KABUSHIKI KAISHA) using a piezoelectric inkjet printer (PX-V630, Seiko Epson Corporation). The obtained prints were left at room temperature for 10 minutes, and the images were rubbed with a fingertip with the overload adjusted to approximately 500 g. Subsequently, the images were visually evaluated for rubfastness. The evaluation criteria for rubfastness were as follows.

A: No smears occur on the surface of the image.

B: Small smears occur on the surface of the image, but the image remains on the recording medium.

C: Smears occur on the surface of the image, and the image a little detaches from the recording medium.

The results of the tests are summarized in Table 2.

TABLE 2

| | Average particle size of | Rubfastness |
|---|---|---|
| | coloring particles (nm) | grade |
| Ink composition 3 | 78 | B |
| Ink composition 4 | 48 | A |
| Ink composition 5 | 97 | C |

As can be seen from Table 2, the rubfastness of printed images depends on the average particle size of coloring particles; average particle sizes equal to or smaller than 80 nm result in good rubfastness, and average particle sizes equal to or smaller than 50 nm result in excellent rubfastness.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-013914 filed Jan. 26, 2011, which is hereby incorporated by reference herein in its entirety.

What is claimed is:

1. Coloring particles comprising a dye and a polymeric dispersant, wherein:
particles of the dye are coated with the polymeric dispersant;
the coloring particles have an average particle size in a range of 10 nm to 80 nm, inclusive, and a dye content in a range of 60% by mass to 90% by mass, inclusive;
the polymeric dispersant is insoluble in water of pH 6.0 to 8.0, inclusive; and
the dye has a solubility parameter according to equation (1) below equal to or larger than 9.20 in water of pH 6.0 to 11.0, inclusive:
Solubility parameter=log (1/Water solubility of the dye, mol/L). (1)

2. The coloring particles according to claim 1, wherein a coefficient of variation of particle size is equal to or lower than 60%.

3. The coloring particles according to claim 1, wherein an average aspect ratio thereof is in a range of 1.0 to 1.2, inclusive.

4. A method for manufacturing coloring particles containing a dye and a polymeric dispersant, comprising:
emulsifying a first liquid and a second liquid to make an emulsion containing the first liquid as a dispersoid, the first liquid containing a lipid solvent and the dye, the second liquid containing water and a low-molecular-weight dispersant at a concentration equal to or higher than double a critical micelle concentration;
mixing the emulsion with the polymeric dispersant to make a content of the polymeric dispersant 10% by mass to 70% by mass, inclusive, relative to a total mass of the dye in the emulsion; then
removing the lipid solvent from the dispersoid to obtain particles of the dye; and then
coating the particles of the dye on at least a partial surface thereof with the polymeric dispersant by changing a pH of the emulsion, wherein:
the polymeric dispersant is insoluble in water of pH 6.0 to 8.0, inclusive;
a mass ratio of the first liquid to the second liquid before the emulsification is in a range of 1/20 to 2/3, inclusive; and
the dye has a solubility parameter of equation (1) equal to or larger than 9.20 in water of pH 6.0 to 11.0, inclusive:
Solubility parameter=log (1/Water solubility of the dye, mol/L). (1)

5. A method for manufacturing coloring particles containing a dye and a polymeric dispersant, comprising:
emulsifying a first liquid and a second liquid to make an emulsion containing the first liquid as a dispersoid, the first liquid containing a lipid solvent and the dye, the second liquid containing water and a low-molecular-weight dispersant at a concentration equal to or higher than double a critical micelle concentration; then
removing the lipid solvent from the dispersoid to obtain particles of the dye; then
mixing the emulsion with the polymeric dispersant to make a content of the polymeric dispersant 10% by mass to 70% by mass, inclusive, relative to a total mass of the dye in the emulsion; and then
coating the particles of the dye on at least a partial surface thereof with the polymeric dispersant by changing a pH of the emulsion, wherein:
the polymeric dispersant is insoluble in water of pH 6.0 to 8.0, inclusive;
a mass ratio of the first liquid to the second liquid before the emulsification is in a range of 1/20 to 2/3, inclusive; and
the dye has a solubility parameter of equation (1) equal to or larger than 9.20 in water of pH 6.0 to 11.0, inclusive:
Solubility parameter=log (1/Water solubility of the dye, mol/L). (1)

6. The method for manufacturing coloring particles according to claim 4, further comprising:
making the polymer dispersant adsorb a monomer by adding the monomer to the emulsion after the coating; and then
polymerizing the monomer.

7. An ink composition comprising the coloring particles according to claim 1.
